(19) United States
(12) Patent Application Publication
(10) Pub. No.: US 2008/0133823 A1
(43) Pub. Date: Jun. 5, 2008

(54) Method For Describing Memory Contents And For Describing The Transfer Of Memory Contents

(76) Inventors: Martin Laichinger, Ebersbach (DE); Joerg Haecker, Esslingen (DE); Andreas Aberfeld, Remseck-Aldingen (DE)

Correspondence Address: KENYON & KENYON LLP, ONE BROADWAY, NEW YORK, NY, 10004, US

(21) Appl. No.: 11/663,512

(22) PCT Filed: Sep. 29, 2005
(86) PCT No.: PCT/EP05/54921

§ 371 Date: Oct. 2, 2007

(30) Foreign Application Priority Data
Sep. 30, 2004 (DE) 10 2004 048 195.4
Jan. 12, 2005 (DE) 10 2005 001 430.5

(51) Int. Cl. G06F 12/02; G06F 12/00

(52) U.S. Cl. 711/103; 711/165; 711/E12.002; 711/E12.008

(57) ABSTRACT

A method for describing contents of a memory and for describing a transfer of contents of a memory or memory area of a vehicle control unit includes the following steps:
providing a description of segments of an area of the memory, including its properties, the segments being designed as physical segments and/or logical segments and/or functional segments;
providing a definition of interfaces and/or methods for transferring memory contents of, from and/or between the segments, the interfaces and/or methods describing the manner, time and other limiting conditions of the transfer.

### BACKGROUND OF THE INVENTION

1. Field of the Invention

The present invention relates to a method for describing memory contents and for describing the transfer of memory contents, and also relates to corresponding computer programs and computer program products.

2. Description of Related Art

The functionality of a vehicle control unit, such as an engine control unit for motor vehicles, must be adapted to the application, i.e., the engine. For this purpose, individual regulating parameters, characteristic values, characteristic maps, etc. are adjusted, i.e., the control unit hardware is adapted by software to a specific engine (application). The effects resulting therefrom are then measured or evaluated in a measurement operation.

In conventional series control units, the result of this adaptation, the application data, is usually stored in non-volatile memories (flash memories). The application data are typically located contiguously in a corresponding data area in the memory area of the control unit. Multiple data areas (segments) of this type, each having different functionalities, are created for a specific application.

The memory area is conventionally segmented according to functional criteria.

During application, data are transferred to writeable memory areas, where they are modified. The effects of the modified data, e.g. on the operating or emission characteristics of an engine, are measured. At the end of operation, or in the case of finally applied subfunctions, these data are usually transferred to non-volatile and read-only (ROM) or large-segmented memory areas. The way in which data of this type move from one memory area to another is currently hard-coded in the common application tools and tailored specifically to each individual application concept. The tiniest changes to the application concept necessitate direct changes to the application tool.

An object of the present invention is to enable information in a control unit memory to be described as generally as possible. The available memory area should be efficiently utilized, and fast and reliable data transmissions (transfer between different segments of the memory area) should be enabled.

### BRIEF SUMMARY OF THE INVENTION

The present invention provides a method for describing memory contents and for describing the transfer of memory contents, as well as a control unit. The present invention also provides a computer program designed in this manner.

According to the present invention, control unit application concepts may now be described holistically. Application tools may represent an emulation concept in different ways, as a function of the selected description. The way in which the information is exchanged, for example by flash programming, copying, etc., no longer has to be hard-coded. According to the present invention, the only requirement is that the described methods are implemented in the application tool.

The ability to describe the segments of the memory area, using elements based on all known description methods, is preferred.

In this regard, it is entirely possible to describe different segments having the same type of data. For example, it is also conceivable to describe memory segments for a memory layout or pages of the application concept or segments within the application data.

It is also advantageously possible for one segment to be part of another segment. In this case, for example, code or data components may be part of a flash memory.

The description of the contents of a memory or memory area and/or the interface and/or methods for transfer is/are provided in a uniformly defined form to a computer program, for example a computer program implemented in a control unit or an application tool.

A computer program of this type may, in a particularly advantageous manner, transfer any memory contents using the described interfaces and/or the described transfer methods without changing its code.

### BRIEF DESCRIPTION OF THE SEVERAL VIEWS OF THE DRAWINGS

FIG. 1 shows an example of a conventional application system, including an application tool.

FIG. 2 shows a schematic diagram for illustrating a an example embodiment of a description of a memory layout according to the present invention.

FIG. 3 shows a diagram for illustrating an example embodiment of a description of an application concept according to the present invention.

### DETAILED DESCRIPTION OF THE INVENTION

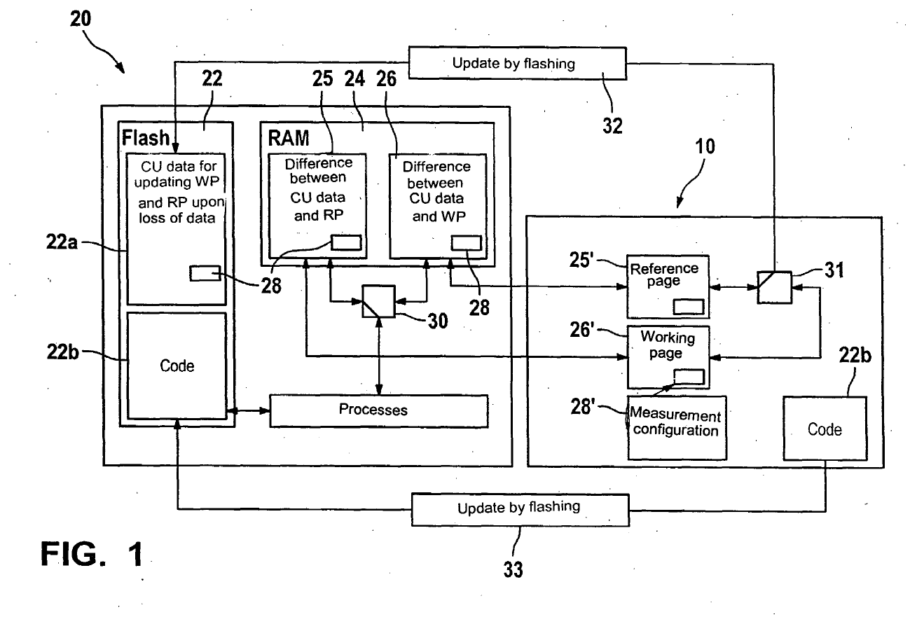

FIG. 1 shows a schematic representation of a conventional application system, including an application tool.

An application tool, which is identified as a whole by reference numeral 10, is used to set a control unit, which in this case is identified as a whole by reference numeral 20.

A non-volatile control unit memory (flash memory) 22 contains programming code (“code”) and data, i.e., control unit data (“CU data”). The CU data in this case are stored in an area 22a and the code in an area 22b. The data in non-volatile memory 22 are used as backup data in the event that data loss occurs in a volatile memory, such as a RAM 24 for example as a result of a voltage interruption. In this case, RAM 24 would be initialized using the data in flash memory 22. A portion of this data area may contain measurement configurations, for example for a startup measurement.

The data in RAM 24 must be modified and are used for working within the framework of the application. Two areas are created in RAM, namely a reference page 25 and a working page 26. Other pages are also possible. Application tool 10 makes it possible to switch between these two areas 25, 26 in a controlled manner (switching means are illustrated schematically and identified by reference numerals 30, 31).

Data are adjusted mainly on working page 26, the effects of such adjustments being verifiable on reference page 25. As the operation progresses, working page 26 may be continuously transferred as a new reference page or used to provide new backup data. A portion of areas 25, 26 may contain measurement configurations 28.

Application tool 10 includes a mirroring of the modifiable data, of the measurement configurations, and of the code. The mirroring of the reference page is identified by 25′ and the mirroring of the working page by 26′. Please note that reference page 25 in RAM 24 may contain or display the difference (difference data) between area 22a and the data of mirroring 25′. Working page 26 may likewise contain difference data with regard to the CU data and mirroring 26′.

The mirroring of code memory area 22b in flash memory 22 is identified by reference numeral 22b. The mirroring of the measurement configurations which may be provided in RAM is identified by reference numeral 28′.

The mirroring function is used to verify, display, and store the work result. The verification may be carried out, for example, by exchanging checksums. In conventional methods, the application tool is hard-coded. Reference is hereby made, for example, to the memory page management function of the INCA application tool known to those skilled in the art. Changes to the application or emulation concept may be made only by simultaneously changing the tool in a coordinated manner.

The CU data may be updated over a logical connection 32 between application tool 10 and flash memory 22, and the code data may be updated via a logical connection 33. The logical connections may be designed as physical connections. The code and data updates may be carried out independently of each other.

Known methods ordinarily involve descriptions of physical groupings (RAM, ROM, EEPROM, flash, etc.), logical groupings (CODE, DATA, VARIABLES, etc.) and functional groupings (working and reference pages of application systems). A description of the information exchange between the individual groupings does not exist and is therefore hard-coded in the application tools. Once again, reference is hereby made to the known memory page management function of the INCA application tool. Descriptions of memory segments according to ASAM MCD 2MC V1.X are also known. These involve this description of memory segments, their types and the type of storable information. This description includes, for example, an item of identification information such as ID, text, etc., an item of localization information, such as start address, length, offset, etc., an item of information on the memory type, RAM, ROM, flash, etc. Information relating to the type of contents (or data, variables) as well as other information, such as that related to access for different application interfaces, is also possible.

This is explained once again below on the basis of the known memory page management concept of the INCA application tool. This tool includes a parallel application concept having an emulator probe (target). Tool components of the application system may also be represented. Information exchanges are represented by functions such as downloading, copying, flash programming, etc. The exchange of information is hard-coded and is not flexible. Adaptations on one page, for example on control unit pages, result directly in certain changes on the other page, i.e., on the application tool page.

The present invention shows how the aforementioned segments (segmentation according to physical or non-physical criteria) and, in particular, information exchanges between the different segments may be described. Such an illustration of methods for exchanging information between the segments makes it possible, according to the present invention, to holistically describe a control unit application concept. According to the present invention, the design of application tools may be variable, i.e., they may represent the emulation concept as a function of this description. The specific way in which the exchange of information must be or is carried out, for example using a flash process, copy operation, etc., does not have to be hard-coded. According to the present invention, the only requirement is that the described methods are implemented in the application tool.

According to the present invention, the segments of a control unit memory are described using elements based on the sum of known descriptions. Depending on the requirements or application, purely physical segments, logical segments, or virtual segments may be described. Interfaces are described for exchanging information with or between these segments. These descriptions may be contained, for example, in an ASAM or an MSR description file.

The description of the segments is illustrated below. Elements based on the sum of known descriptions are used to describe the segments. It is entirely possible to describe different segments (for example, memory segments for a memory layout of the control unit, pages of the application concept or segments within the application data). In particular, it is conceivable for one segment to be part of another segment. For example, a code segment and/or a data segment may be part of a flash segment. Features of a description of this type are listed below by way of example, one feature or another being optional, depending on the purpose or specific conditions:
Identification information (ID, text, etc.);
Localization information (start address, length, offset, internal, external, etc.);
Information on the memory type (RAM, RAM buffered, ROM, flash, EEPROM, etc.);
Access type (read and/or write);
Segmentation information (segment extract, entire segment, cross-segment, virtual segment);
Addressability information as a function of the segmentation (for example, addressable across segments as a whole or individually or directly addressable in the case of a segment extract, the control unit automatically supplying missing information as needed);
Information on type of contents (code, online or offline data, variables, etc.);
Information for access via different application interfaces (mapping information, etc.);
Initialization type, unless described as an auto-transfer method;
Other attributes (fallback, working, reference, startup page, etc.).

The transfer methods which may be used according to the present invention are described below. Interfaces which describe the manner, time, and other limiting conditions of information flow are defined for the flow of information of contents from, to or between the segments described according to known methods. Features of a description of this type are listed below, one feature or another being optional, depending on the purpose or specific conditions:
Identification information (ID, text, etc.);
Source and destination segment (output and target segment);
Execution information (automatic, manual);
Execution time (start phase, operating phase, stop phase, other phases or trigger events);

Execution conditions/restrictions (certain operating states, for example v=0 km/h, validity of grouping contents, for example data in RAM no longer valid due to loss of voltage, etc.),
Execution method (for example, external low-level flash process, internal flash process, simple copying of memory contents, etc.), which may vary depending on the interface used;
Execution details, if necessary, which may vary depending on the interface used (for example, external low-level flash process including job language, communication interface command including XCP page copy command, etc.).

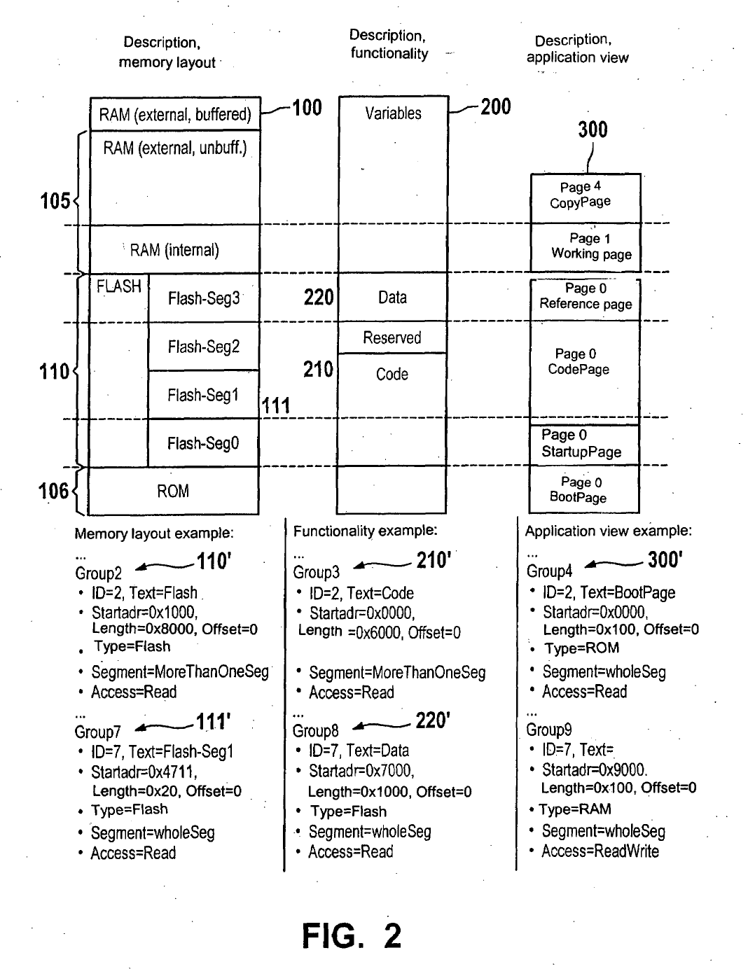

FIG. 2 shows a specific exemplary embodiment of a memory layout description provided according to the present invention. The diagram shows three types of description used, namely a description according to the memory layout (100), a description according to the functionality (200) and a description according to the application or from the application view (300). In particular, reference is made to the explanatory notes contained in FIG. 2 with regard to the individual embodiments of the descriptions. Once again, reference is hereby made to the fact that the individual description types are not mutually exclusive. Reference numeral 100 designates a typical memory map of a control unit. In particular, volatile memory areas (RAM areas 105), non-volatile memory areas (flash areas 110) and a ROM area 106 are illustrated. Additional characteristics of the illustrated memory layout are listed below the description of the memory layout. 110′ designates the description of entire flash memory area 110. 111′ characterizes the description of a physical segment within flash memory area 110 in greater detail. Descriptions 110′, 111′ are examples of the holistic description of the memory map provided according to the present invention.

The description identified by 200 of a memory layout according to its functionality is divided into two main areas, namely area 210 for storing code, i.e., for example software for controlling the control unit functions, and a data area 220 in which, for example, control units and/or engine parameters are stored. Additional characteristics of these areas are again listed under 210′ and 220′.

The description of the memory layout from the application view is shown under 300. Once again, the special characteristics are listed under 300′.

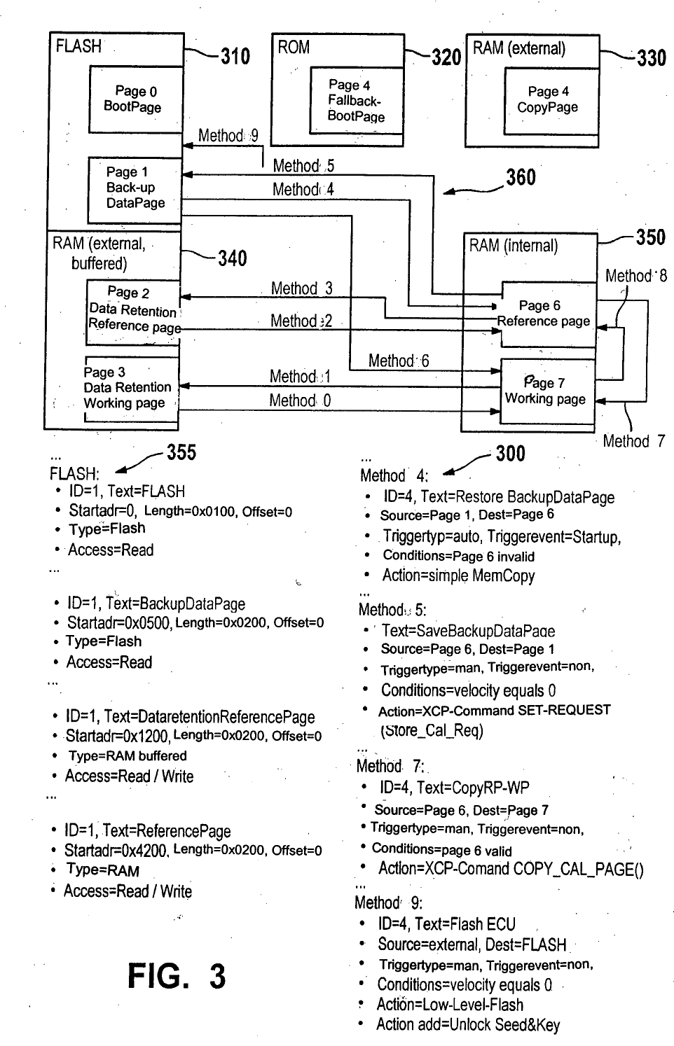

The description of an application concept description, implementable according to the present invention, is illustrated in FIG. 3. Example transfer methods for transmitting data between the individual segments are also shown. With regard to the details, reference is again made to the explanatory notes contained in FIG. 3.

The different memory areas of the control unit described above with reference to FIGS. 1 and 2 are shown. The flash control area in this case is identified by 310 and the RAM memory area by 340. Details relating to the flash memory are listed under 355 in FIG. 3. In FIG. 3, the ROM area is identified by 320 and an external RAM area by 330.

FIG. 3 shows different methods for transmitting or transferring memory contents between different memory areas. It is important to note that, according to the present invention, all transfer methods are supported in the control unit, i.e., a great deal of flexibility exists with regard to the many different transfer methods which may be used.

A variety of applicable transfer methods are listed under 300. The various transfer methods are specified below on the basis of several examples. Reference is hereby made to the explicit explanatory notes in FIG. 3 (under 300) with regard to the transfer methods not discussed specifically here. For example, if data are to be transferred from the reference page in internal RAM 350 to the corresponding area of flash memory 310 (referred to there as “Page 1. Backup DataPage”), transfer method 5 identified by 360 is used. This transfer method requires corresponding programming of flash memory 310, as specified by the characterization “XCP Command, SET_REQUEST (Store_Cal_Req) according to Method 5 under 300. Although it would also be possible to use a simple low-level flash for transferring data to (non-volatile) flash memory 310, this is not preferred for security reasons.

A transfer method of this type, using only a copy procedure, is described, for example, under Method 7. In this case, data in internal RAM 350 is copied from the reference page to the working page (see also FIG. 1, reference numerals 25, 26). The corresponding copy command is listed under Method 7, reference numeral 300, as “XCP-Command COPY_CAL_PAGE( ).

The object and advantages of the present invention are summarized once again below: The present invention has two main components. First, according to the present invention, a general description of the information stored in the control unit is implemented as a segment object for different purposes by combining the known special methods, for example a description of the memory layout, application concept (with the addition of transfer methods) and data differentiation. A description of transfer methods from, to and between the individual segments is also provided. These transfer methods represent defined interfaces between segments in the control unit memory. The application concept implemented in the control unit may be described via these descriptions. An application tool is able to display and apply this concept on the basis of the description without having to be specially coded, provided that the described transfer methods are supported.

An advantage is achieved, in particular, by the fact that there is no need for coordination between control unit and tool manufacturers, which is unavoidable when using conventional methods. Any tool which supports the described methods may be used without prior coordination. Furthermore, an application/emulation concept may be individually customized in the control unit to the available resources (memories, interfaces, etc.) and adapted according to the state of development, again without requiring any coordination with tool manufacturers. Individual customer requests may be met without taking into account possible effects on the application tool to be used. A tool manufacturer, for his part, has to maintain only one universal standard solution. The application/emulation concept to be applied with regard to a control unit is compilable from standardized transfer methods. Error susceptibility decreases due to the ability to use more advanced standard modules in this connection. Upgrades are carried out only by adding more transfer methods or by upgrading with additional standard modules. It is particularly advantageous that technically necessary adaptations may be carried out more easily, while continuously shortening development cycles, compared to conventional methods, since they are flexible with regard to the control unit and require only partial customization with regard to the tool.

1-8. (canceled)

9. A method for describing contents of a memory of a vehicle control unit and for describing a transfer of memory contents in a transfer involving the memory of the vehicle control unit, comprising:
providing descriptions of segments of a memory area of the memory, wherein the descriptions include properties of the segments of the memory area, and wherein the segments are configured as at least one of physical segments, logical segments, and functional segments; and
providing definitions of at least one of interfaces and methods for transferring memory contents in a transfer which involves the segments, wherein the at least one of the interfaces and methods describes stipulated conditions of the transfer, the stipulated conditions including at least the manner and the time of the transfer.

10. The method as recited in claim 9, wherein the segments of the memory area are described using elements based on existing description types.

11. The method as recited in claim 9, wherein one of the segments is part of another segment.

12. The method as recited in claim 9, wherein the descriptions of the segments of the memory area of the memory and the definitions of the at least one of the interfaces and methods for the transfer are provided to a computer program in a uniformly defined form.

13. The method as recited in claim 12, wherein the computer program is configured to transfer memory contents using the at least one of the interfaces and methods for the transfer without changing the code of the computer program.

14. A control unit for a motor vehicle, comprising:
a memory, wherein the memory is configured to be operated according to a method including:
providing descriptions of segments of a memory area of the memory, wherein the descriptions include properties of the segments of the memory area, and wherein the segments are configured as at least one of physical segments, logical segments, and functional segments; and
providing definitions of at least one of interfaces and methods for transferring memory contents in a transfer which involves the segments, wherein the at least one of the interfaces and methods describes stipulated conditions of the transfer, the stipulated conditions including at least the manner and the time of the transfer.

15. A computer-readable storage medium storing a computer program which carries out, when executed on a computer, a method for describing contents of a memory of a vehicle control unit and for describing a transfer of memory contents in a transfer involving the memory of the vehicle control unit, the method comprising:
providing descriptions of segments of a memory area of the memory, wherein the descriptions include properties of the segments of the memory area, and wherein the segments are configured as at least one of physical segments, logical segments, and functional segments; and
providing definitions of at least one of interfaces and methods for transferring memory contents in a transfer which involves the segments, wherein the at least one of the interfaces and methods describes stipulated conditions of the transfer, the stipulated conditions including at least the manner and the time of the transfer.
